(19) United States
(12) Patent Application Publication
(10) Pub. No.: US 2024/0261983 A1
(43) Pub. Date: Aug. 8, 2024

(54) Changer, Changer System and Method for Changing Tools to Be Used Consecutively on a Robotic Arm

(71) Applicant: GRIP GmbH Handhabungstechmik, Dortmund (DE)

(72) Inventor: Hasan Canti, Dortmund (DE)

(21) Appl. No.: 18/578,423

(22) PCT Filed: Jun. 23, 2022
(86) PCT No.: PCT/EP2022/067168

§ 371 Date: Jan. 11, 2024

(30) Foreign Application Priority Data
Jul. 14, 2021 (DE) 10 2021 118 208.5

(51) Int. Cl. B25J 15/04

(52) U.S. Cl. CPC B25J 15/04

(57) ABSTRACT

Described and shown is a changer for changing tools to be used consecutively on a robotic arm having a base part and a changer part, which are connected to one another in a connecting position, in such a way that the base part can be adjusted from the connecting position in an extracting direction relative to the changer part into a separating position separated from the changer part and back to the connecting position in an insertion direction, and wherein the base part has a locking mechanism which can be adjusted from a locking position to a unlocking position, releasing a separation of the base part and back, and interacting with the changer part. In order for simple and inexpensive changer systems to be provided, it is provided for the locking mechanism to have a receptacle for receiving an actuating means in the extracting direction or an actuating means for inserting into a receptacle in the insertion direction, in that the locking mechanism is designed perpendicular to the extracting direction for positively receiving the actuating means, and in that the locking mechanism is designed to be able to be adjusted from the unlocking position to the locking position by adjusting the receptacle or the actuating means in the unlocking direction relative to the base part and/or by adjusting the receptacle or the actuating means in the locking direction relative to the base part.

### CROSS-REFERENCE TO RELATED APPLICATIONS

This application is the United States national phase of International Application No. PCT/EP2022/067168 filed Jun. 23, 2022, and claims priority to German Patent Application No. 10 2021 118 208.5 filed Jul. 14, 2021, the disclosures of which are hereby incorporated by reference in their entireties.

### BACKGROUND OF THE INVENTION

### Field of the Invention

The invention relates to a changer for changing tools to be used consecutively on a robotic arm with a base part and a changer part, wherein the base part provides an assembly section on the head side of the changer for mounting the robotic arm and the changer part provides an assembly section on the base side of the changer for mounting a tool, wherein the base part and the changer part are connected to one another in a connecting position in such a way that the base part can be adjusted from the connecting position in an extracting direction at least substantially directed from the assembly section of the changer part to the assembly section of the base part relative to the changer part into a separating position separated from the changer part and back into the connecting position in an opposite insertion direction, and wherein the base part has a locking mechanism interacting with the changer part and adjustable from a locking position, blocking a separation of the base part from the changer part from the connecting position in the extracting direction, into an unlocking position, releasing a separation of the base part from the changer part from the connecting position in the extracting direction, and back. The invention further relates to a changer system for changing tools to be used consecutively on a robotic arm comprising a changer and method for changing a tool.

### Description of Related Art

Changers for changing tools to be used consecutively on a robotic arm are used to perform repeatable and quick tool changes. Typically, on a robotic arm equipped with a base part, a tool equipped with a changer part can be quickly and accurately attached and removed again. In order to eliminate the need for manual intervention, the tool change is carried out using the robotic arm in particular and without the manual intervention of an operator. For this purpose, the tool to be picked up can be connected to the changer part on an assembly section of the changer part and held in a holder by means of the changer part. The robotic arm is then connected to the base part by means of an assembly section and can bring the base part into engagement with the changer part in an insertion direction opposite to the extracting direction. The changer made up of the base part and changer part is then present in a connecting position from which the base part can be lifted again in the extracting direction opposite the changer part in order to adjust the changer back into a separating position.

When connecting the base part and changer part or thereafter, a locking mechanism can be operated manually or automatically and adjusted from an unlocking position that releases the adjustment of the base part in the separating position into a locking position that prevents the adjustment of the base part into the separating position. The robotic arm can then be removed from the holder together with the tool. At a later point in time, however, the robotic arm can insert the changer part back into the holder, and thereby or subsequently adjust the locking mechanism back from the locking position into the unlocking position. The robotic arm can then be separated from the tool again in the extracting direction.

The locking mechanism of the base part typically has at least one adjustable bolt, which is designed to form a positive connection with the changer part. Usually, the bolt, which is arranged, for example, in a pin of the base part, can engage a projection in the locking position in a recess of the changer part in the extracting direction. This positive locking is cancelled out when the locking mechanism is adjusted to the unlocking position.

In order to equip a robotic arm with a number of different tools consecutively, changer systems typically include a number of tools and changer parts. As a result, changer systems are usually complex and expensive.

### SUMMARY OF THE INVENTION

The object of the present invention is therefore to design and further develop the changer, the changer system and the methods of the type mentioned at the outset and explain in more detail in such a way that simpler and more cost-effective changer systems can be provided.

This object is achieved in a changer as described herein by:
the locking mechanism has a receptacle for receiving an actuating means at least substantially in the extracting direction in the connecting position or an actuating means for inserting into a receptacle at least substantially in the insertion direction in the connecting position,
the locking mechanism is designed for positively receiving the actuating means in a locking direction being at least substantially perpendicular to the extracting direction and/or in an unlocking direction being at least substantially opposite to the locking direction in the receptacle and
the locking mechanism is designed to be adjustable by adjusting the receptacle or the actuating means in the unlocking direction relative to the base part and/or by adjusting the receptacle or the actuating means in the locking direction relative to the base part from the unlocking position to the locking position.

The object is also achieved by means of a changer system as described herein in that the changer is designed as described herein.

This object is further achieved as described herein by means of a method with a changer system as described herein
in which the base part is placed in the connecting position with a receptacle or with an actuating means relative to a holder in the insertion direction on an actuating means fixed on the holder or is inserted in a receptacle fixed on the holder,
in which the base part is adjusted relative to the holder in the locking direction after being placed on the actuating means or after being inserted into the receptacle and
in which, by adjusting the base part in the locking direction, the receptacle or the actuating means is adjusted relative to the base part in the unlocking direction and the actuating means interacts positively with the locking mechanism and the locking mechanism is adjusted from the locking position to the unlocking position.

The said object is also achieved as described herein by means of a method with a changer system as described herein
in which the base part is inserted in the insertion direction into a changer part held by a holder,
in which the base part with a receptacle or with an actuating means is placed in the insertion direction on an actuating means fixed on the holder or is inserted into a receptacle fixed on the holder,
in which the base part is adjusted relative to the holder in the unlocking direction after being placed on the actuating means or after being inserted into the receptacle and
in which, by adjusting the base part in the unlocking direction, the receptacle or the actuating means is adjusted relative to the base part in the locking direction and the actuating means or the receptacle interacts positively with the locking mechanism and the locking mechanism is adjusted from the unlocking position to the locking position.

Both the base part and the changer part each have at least one assembly section. The assembly section can be designed to be flat at least in sections and, for example, be firmly connected to a tool or a robotic arm by means of a screw connection. In particular in the connecting position of the changer, the two assembly sections are arranged at the head and base ends of the changer facing away from one another. The robotic arm and the tool can thus be connected by connecting the base part and the changer part and separated from each other again by separating the base part and the changer part.

The base part and the changer part correspond to each other, in particular opposite to the respective assembly section, at least in sections, in particular with insertion sections. The insertion sections can be designed at least substantially planar in sections, namely in an insertion direction opposite to the extracting direction relative to the changer part.

In the connecting position, the base part and the changer part are inserted into each other. This means that the corresponding sections for insertion, in particular the insertion sections, are in contact with one another and/or inserted into one another. It is less important whether the changer part is inserted into the base part or vice versa. On the other hand, the separating position is present when the base part and the changer part are separated from one another, i.e. moved away from one another. In this case, the extracting direction at least substantially points from the assembly section of the changer part to the assembly section of the base part, wherein the extracting direction in particular can be aligned at least substantially normal to at least one assembly section.

The changer can in principle be adjusted between a locking position and an unlocking position by means of the locking mechanism in particular. In the locking position, the base part and the changer part are fixed to one another and cannot be separated from one another by a relative movement of the base part relative to the changer part in the extracting direction. Only when the locking mechanism is adjusted from the locking position to the unlocking position can the base part be lifted relative to the changer part.

During the adjustment of the locking mechanism, the base part and the changer part shall, if necessary, only be arranged at least substantially in the connecting position. Adjusting the locking mechanism to the locking position can, for example, cause the base part and the changer part, in particular by force, to reach the connecting position, for example by a sliding of inclined or conical locking surfaces of the locking mechanism and of the changer part towards one another.

Since the base part has the locking mechanism, the locking mechanism is assigned to the robotic arm. The robotic arm can then be connected consecutively to a variety of tools by means of changer parts, whereby the changer parts can be designed simply and inexpensively as the changer parts do not require a locking mechanism. The receptacle of the locking mechanism and/or the actuating means of the locking mechanism can be provided on the base part and be accessible from the outside there. This enables positive locking of the base part and a holder for adjusting the locking mechanism of the base part. For this purpose, the receptacle and a corresponding, for example pin-shaped, actuating means engage in one another. In this case, whether the receptacle is provided on the base part and the actuating means on the holder or vice versa fundamentally plays a secondary role. It can also be provided that the base part and the holder each have an actuating means and a receptacle, which are designed corresponding to each other respectively.

The receptacle is advantageously oriented in such a way that it is designed to receive the in particular pin-shaped actuating means when the base part is placed on a holder. A receptacle arranged on the base part can therefore at least substantially be attached to the actuating means of a holder in the insertion direction. Alternatively or additionally, an actuating means arranged on the base part can be inserted at least substantially in the insertion direction in a receptacle of a holder.

The receptacle and/or the actuating means can be accessible from the outside in the locking position and in the unlocking position on the base part in order to achieve positive locking with the actuating means and/or with the receptacle. The positive locking of the actuating means in the receptacle can therefore act at least in the unlocking direction and/or the locking direction and thus at least substantially perpendicular to the extracting direction of the base part. This makes it easy to adjust the locking mechanism on the holder.

In a first particularly preferred embodiment of the changer, the changer part has in the extracting direction at least substantially opposite the insertion direction at least one holding surface for holding the changer part in the direction of gravity of a holder. The changer part can thus be safely placed or held on the at least one holding surface, for which a plurality of holding surfaces, for example at least two or at least four holding surfaces, can be suitable. If several holding surfaces are provided on opposite sides of the changer part, the changer part can be held stable in a holder.

The base part can have a securing element for engaging in the receptacle of the locking mechanism. For the sake of simplicity, engagement takes place in a positive-locking manner in the unlocking direction relative to the base part. In particular, not only an actuating means can therefore engage in the receptacle, but also the securing element, which can be formed as pin-shaped at least in sections. If the securing element engages in the receptacle in the unlocking direction in a positive-locking manner in the locking position, the receptacle and thus the locking mechanism is secured against unlocking, since the adjustment of the locking mechanism in this direction is blocked by the securing element.

The securing element can be adjusted against a restoring force of a spring means of the base part out of the receptacle. The securing element thus engages forcefully in the receptacle due to the restoring force when aligned correctly with the receptacle. In principle, the securing element can engage in the receptacle on a side of the receptacle opposite to the actuating means. Stop surfaces can be assigned to the securing element such that the securing element can be adjusted from a defined as required position not positively engaging in the receptacle to a defined position engaging in the receptacle.

The securing element can therefore be designed to be insertable at least substantially in the insertion direction into the receptacle and to be removable from the receptacle at least substantially in the extracting direction. In this way, when inserting the base part and changer part into one another in the insertion direction, the securing element can be pressed out of the receptacle very easily by the actuating means. If the securing element no longer engages in the receptacle, it is possible to adjust the receptacle, whereby the locking mechanism, in particular the receptacle, is unlocked.

In order to be able to engage in the receptacle from substantially opposite directions, for example on the one hand by means of the actuating means and on the other hand by means of the securing element, the receptacle can be designed as a passage opening. The actuating means can thus displace a securing element engaging in the receptacle from the other side from the receptacle when the base part is placed on the actuating means.

In addition, an indicating device can be provided which can indicate whether the locking mechanism is secured or not. For this purpose, the indicating device is provided to be adjustable from a position indicating the positive locking of the locking mechanism by the securing element in the locking position to a position indicating the release of the locking mechanism, for example in the locking position. In this case, an indicating element of the indicating device can protrude outwards from the base part in an unlocking direction when the locking mechanism is released. In the case of positive locking, the base part can then no longer be provided to be protruding. The indicating element then indicates the position of the base part and/or the locking mechanism, wherein it is less significant in which the position the indicating element protrudes outwards in relation to the base part and in which position this is not the case. It is particularly simple and therefore expedient if the indicating element is formed by the securing element or if the indicating element is directly and firmly connected to the securing element, and in particular in the extracting direction of the base part.

The receptacle or the actuating means can be provided on a flap element of the locking mechanism adjustable relative to the base part in order to easily adjust the locking mechanism between the unlocking position and the locking position. For this purpose, the receptacle and/or the actuating means of the base part is provided on the base part accessible from the outside. If the flap element is designed to be a slider, the locking mechanism can be adjusted easily and reliably.

If the flap element is designed for actuating a toggle lever unit of the locking mechanism, a stable, self-locking of the base part can be achieved on the changer part. For this purpose, the flap element is connected via at least one toggle lever to at least one adjustable bolt of the locking mechanism, which can achieve positive locking with the changer part in the locking position. When adjusting the flap element, the toggle lever unit goes beyond a dead centre. When the locking position is reached, a stable state of the at least one bolt is thus achieved because the toggle lever unit must first be adjusted back again beyond the dead centre in order to adjust the locking mechanism to the unlocking position.

The changer system according to the invention has a changer, wherein the base part is provided to be connected to the robotic arm and/or the changer part to the tool. In this case, the changer is designed as described above. The locking mechanism is thus assigned to the robot. Thus only one locking mechanism is required per robotic arm, whereby a locking mechanism is not required for the changer parts assigned to the tools. This reduces costs thanks to less complex components, because a larger number of tools are typically to be connected to a robotic arm.

If a holder is provided, the tools can be changed accurately and quickly. The holder can also be designed to hold changer parts connected to the tool and separated from the base part securely. The holder supports the changer part in the separating position in the direction of gravity. The holder can also hold the changer part in the connecting position. However, the holder can also be used independently of this to adjust the locking mechanism from the locking position to the unlocking position and back.

For holding the changer part, at least one support surface corresponding to the holding surface of the changer part can be provided on the holder. For reliable holding, at least two or four support surfaces corresponding to the at least two or four holding surfaces of the changer part can be provided.

The holder can have an actuating means and/or a receptacle, wherein the actuating means can be engaged with a receptacle of the base part and/or an actuating means of the base part can be engaged with the receptacle. In this case, it is particularly simple to design the actuating means substantially in the form of a pin.

The bracket may have an U-shaped recess. The U-shaped recess can then grip the changer part that has been inserted and also cause an adjustment of the locking mechanism of the base part. The actuating means and/or the receptacle of the holder is preferably provided for this on the U-cross member of the holder. Thus at least one support surface can also be provided in each case on one of the two opposite U-legs. There can also be at least two supporting surfaces on the U-legs at least substantially opposite to one another in order to prevent the changer part from tilting. Particularly preferably, two support surfaces are provided for each U-leg. The holder can therefore be designed by the U-shape such that the holder engages in the region of the U-cross member either by means of the actuating element in the receptacle on the base part or by means of the receptacle achieving a positive-locking connection with the actuating element of the base part.

The holder can alternatively or additionally have at least one securing surface, which for the sake of simplicity can be provided opposite to and/or facing away from at least one support surface. In the separating position and/or in the unlocking position, the securing surface can achieve a positive-locking connection of the changer part to the holder in the extracting direction against a pulling of the changer part out of the holder in the extracting direction. This prevents the changer part from accidentally slipping or falling off the holder. For the sake of simplicity, at least two or four securing surfaces can be provided for this.

If at least one groove providing the holding surface and the securing surface is provided, the holder can engage in the groove with at least one corresponding engagement section if the changer in the holder is adjusted in the unlocking direction relative to the holder. The changer part then remains reliably held on the holder in the direction of gravity and extracting direction even after unlocking in relation to the base part. Of course, the at least one engagement section could also be provided on the changer part and the at least one groove on the holder. For simplicity, the groove extends at least substantially in sections parallel to the locking direction and/or the unlocking direction. It is particularly reliable if a plurality of opposing grooves and engagement sections are provided, which are arranged accordingly on two opposite sides of the changer part and the holder, in particular U-legs. The at least one groove can alternatively or additionally have an extracting stop which interacts with the assigned engagement section if the changer part is accidentally adjusted in the locking direction relative to the base part.

In the method for separating the changer, the base part is first placed in the connecting position with a receptacle and/or with an actuating means relative to a holder in the insertion direction on the actuating means fixed on the holder and/or inserted in a receptacle fixed on the holder. The actuating means then engages in the receptacle. The base part is then adjusted in the locking direction, in particular at least substantially perpendicular to the insertion direction, relative to the holder. By adjusting the base part in the locking direction—wherein the receptacle and/or the actuating means in the base part are adjusted relative to the base part in the unlocking direction—the actuating means and/or the receptacle interact positively-locking with the locking mechanism and an adjustment of the locking mechanism from the locking position to the unlocking position is effected. Although the changer is then at least substantially still in the connecting position, the base part and the changer part can now be separated from one another, for example by pulling out. Separation takes place by means of a robotic movement of the base part relative to the changer part in the extracting direction, wherein the base part is lifted off the changer part as required. When placing the base part on the holder, the at least one support surface and the at least one holding surface can be brought into contact with one another in order to reliably hold the changer part after unlocking from the base part.

In a first, particularly preferred embodiment of the method, the base part is lifted from the connecting position relative to the changer part in the extracting direction after adjusting the locking mechanism to the unlocking position. The changer part held in the holder is then held in the direction of gravity after the base part is lifted off the holder. The base part is then in the separating position and can be connected and locked with another changer part, in particular held on a different holder.

When placing the base part with the receptacle on the actuating means of the holder, a securing element can preferably be forcibly moved out of the receptacle. It is particularly simple if the actuating means presses the securing element out of the receptacle when the base part is placed on the holder. The securing element in the receptacle blocks or secures the adjustment of the receptacle and releases the adjustment of the receptacle again if the securing element no longer engages in the receptacle. The actuating means then engages in the receptacle and has pressed the securing element out of the receptacle as required. Due to the positive-locking connection between the actuating means and the receptacle, a subsequent adjustment movement of the base part relative to the holder and/or the actuating means can cause an adjustment of the locking mechanism to the unlocking position and back to the locking position.

An indicating device can indicate a positive locking of the locking mechanism in the locking position and/or indicate a release of the locking mechanism for adjusting the locking mechanism. The indicating device can be easily adjusted when placing the base part with the receptacle on the actuating means of the holder and/or when lifting the base part with the receptacle from the actuating means of the holder in order to indicate the two different states. The indicating device can be connected to the securing element in such a way that an indicating element of the indicating device protrudes from the base part when the locking mechanism is released and/or dips into the base part when the locking mechanism is secured. The dipping and protruding of the indicating element can also be reversed here in relation to the positions mentioned. It is particularly simple and expedient if the securing element and the indicating element are both formed in a pin-shaped manner. Then, for example, the securing element can press out of the receptacle and thereby simultaneously adjust the indicating element.

In the second method according to the invention, which can be carried out consecutively together with the first method according to the invention, the changer is initially in the separating position and the base part with a receptacle and/or an actuating means is placed in the insertion direction on a changer part held by a holder. In this case, the actuating means engages in the receptacle, wherein whether the receptacle is provided on the base part or on the holder is less significant. The actuating means is then provided on the respective other component. After inserting the actuating means into the receptacle, the base part is adjusted relative to the holder in the unlocking direction. By adjusting the base part in the unlocking direction, the positive-locking connection of the actuating means and receptacle causes an adjustment of the locking mechanism from the unlocking position to the locking position, wherein the receptacle is adjusted in the locking direction in relation to the base part. The changer, i.e. the base part and the changer part, is then in the connecting position and locked. The changer is furthermore still located in the immediate vicinity of the holder, for example at least substantially gripped by the U-shape of the holder.

After adjusting the locking mechanism to the locking position, the entire changer can be lifted in the connecting position relative to the holder in the extracting direction. If the tool on the changer part is too long and/or wide, the changer part can be moved to the side after being lifted from the holder so that the tool does not collide with the holder.

By lifting the changer from the actuating means and/or by pulling it out of the receptacle, a securing element for securing the locking mechanism can be moved into the receptacle or also into the flap element in the locking position. This prevents further adjustment of the locking mechanism to the unlocking position. This can be achieved by pressing the securing element into the receptacle released by the actuating means as a result of the restoring force of the spring means. Alternatively or additionally, the securing element can be forced back into the receptacle by a spring force.

An indicating device can be used so that a user can quickly see whether the locking has taken place or whether the locking mechanism is secured. The indicating device can be designed as described above.

### BRIEF DESCRIPTION OF THE DRAWINGS

The invention is explained in greater detail below by means of a drawing representing only one exemplary embodiment. The drawings show:

FIG. 1A-B two changer systems according to the invention, each with a changer according to the invention and a holder in different positions in a perspective view,

FIG. 2A-E method steps for separating the base part from the changer part of the changer from FIG. 1 schematically in a side view,

FIG. 3A-E method steps for connecting the base part and the changer part of the changer from FIG. 1 schematically in a side view,

FIG. 4A-C the base part of the changer system in a locking position and a detail of the base part from FIG. 1A in perspective view and in sectional view,

FIG. 5A-C the base part of the changer system in an unlocking position and a detail of the base part from FIG. 1A in perspective view and in sectional view, and

FIG. 6A-C the changer system from FIG. 1A in different positions in a lateral sectional view.

### DESCRIPTION OF THE INVENTION

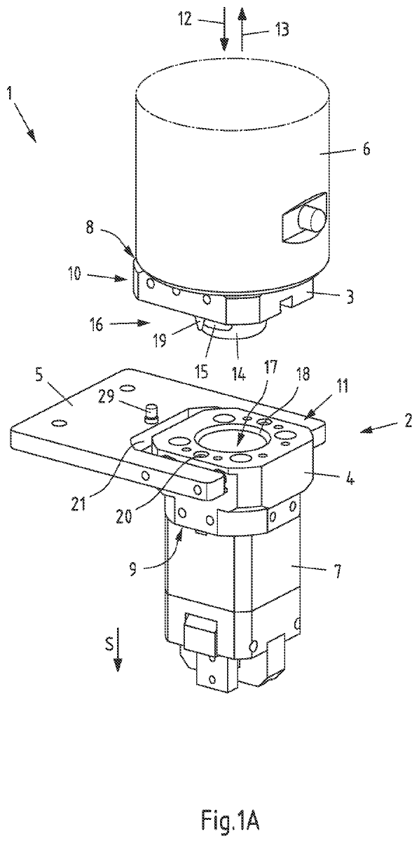

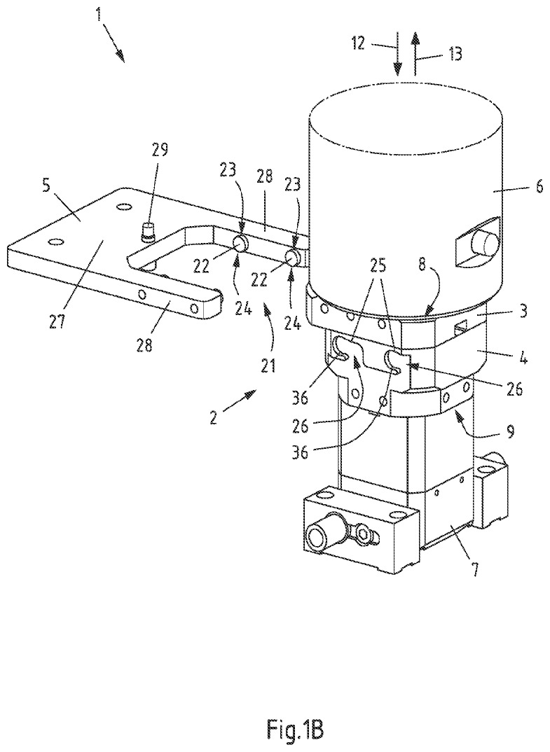

In FIG. 1A-B, a changer system 1 is shown in each case. Each changer system 1 has a changer 2 comprising a base part 3, a changer part 4 and a holder 5. A robotic arm 6 is connected to the base part 3 in each case and a tool 7 is connected to the changer part 4. The tools 7 shown in FIG. 1A-B are different. However, the other elements correspond to each other. The base part 3 is connected to the robotic arm 6 by means of a head-side assembly section 8. The changer part 4 is connected to the tool 7 by means of a base-side assembly section 9. The base part 3 can be inserted into the changer part 4 by means of an insertion section 10 of the base part 3 in an insertion direction 11 and is in the present case formed to abut with the insertion section 10 of the base part 3 on the insertion section 11 of the changer part 4. The base part 3 and the changer part 4 can thus be brought into a connecting position. In the opposite direction to the insertion direction 12, the base part 3 can be separated from the changer part 4 in an extracting direction 13. The base part 3 and the changer part 4 are then in a separating position. Thus, the insertion direction 12 points, at least in the connecting position, from the assembly section 8 of the base part 3 to the assembly section 9 of the changer part 4, while the extracting direction 13 points, in the connecting position, from the assembly section 9 of the changer part 4 to the assembly section 8 of the base part 3.

In FIG. 1A, the tool 7 is shown in the separating position and held in the holder 5 by means of the changer part 4, wherein the base part 3 is arranged on the robotic arm 6 away from the changer part 4. The base part 3 of FIG. 1A can be inserted into the changer part 4 along an insertion direction 12—in this case vertically downwards—in order to reach the connecting position. On insertion, a pin 14 of the base part 3 with two bolts of a locking mechanism 16 facing away from one another dips into a recess 17 of the changer part 4 corresponding to the pin 14. The bolts 15 are present and in this respect preferably designed to grip behind a projection 18 in the recess 17 when the bolts 15 are pushed out accordingly. In addition, when inserting, two opposite centring elements 19 of the base part 3 dip into a centring bore 20 of the changer part 4 in the insertion direction 12 in order to centre the base part 3 in the changer part 4 transverse to the insertion direction 12.

In the connecting position shown in FIG. 1B, the tool 7 is indirectly connected to the robotic arm 6 via the changer 2, wherein the base part 3 and the changer part 4 are inserted into one another. The base part 3 and the changer part 4 are also locked to one another by means of a locking mechanism 16 of the base part 3 that is not shown in FIG. 1B. To separate the base part 3 and the changer part 4, the locking mechanism 16 must be adjusted from the locking position to the unlocking position.

The holder 5 has an U-shaped recess 21 and four, in the present case pin-shaped, engagement sections 22. Each of the two U-legs 28 of the holder 5 has two engagement sections 22. The engagement sections 22 have support surfaces 23 which hold the changer part 4 in the separating position and support it against the direction of gravity S. Corresponding to the four support surfaces 23, four holding surfaces 25 are provided on the changer part 4, wherein a support surface 23 corresponds to a holding surface 25 in each case. The support surfaces 23 are in contact with the holding surfaces 25 when the changer part 4 is held by the holder 5. Furthermore, four securing surfaces 24 are provided which prevent the changer part 4 from being unintentionally lifted off in the extracting direction 13. In the changer system 1 shown and in this respect preferred, this takes place by contacting the engagement sections 22 with the securing surfaces 24 arranged on the engagement sections 22, but not necessarily on the underside. A total of four grooves 26 are provided on the changer part with the holding surfaces 25, into which the engagement sections 22 can engage. However, the grooves could also be omitted. On the U-cross member 27, a pin-shaped actuating means 29 for engaging from below, thus against the direction of gravity S and relative to the receptacle in the extracting direction 13, is arranged in a receptacle 30 of the locking mechanism 16 of the base part 3.

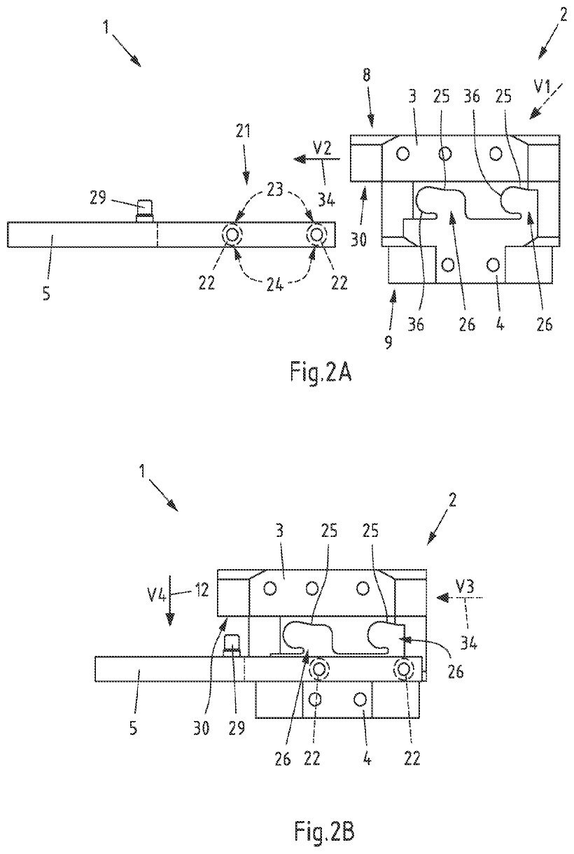

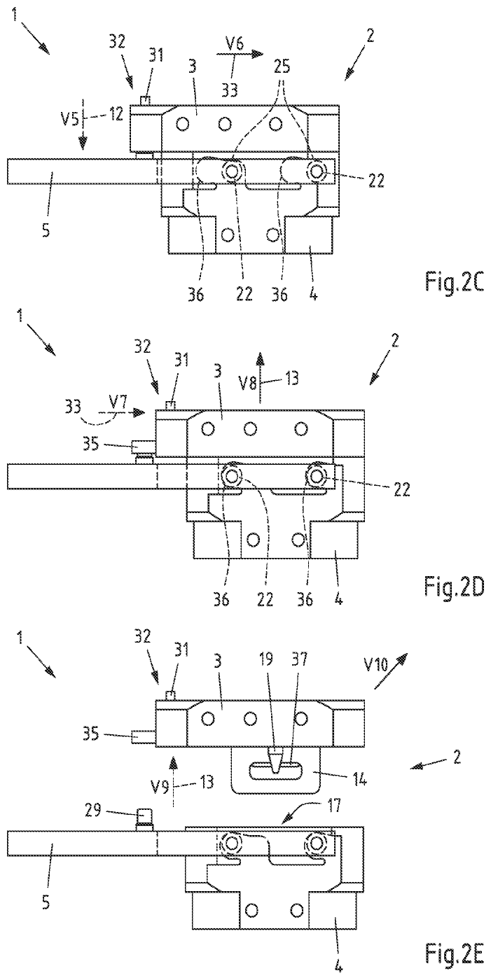

FIG. 2A-E shows the sequence of a method using the changer system 1 and the changer 2 in which the base part 3 and the changer part 4 are separated from one another. The directions V1,V3,V5,V7,V9 with the arrows with dashed lines point in each case in the directions which were followed in FIG. 2A-C with the changer 2 and in FIG. 2D-E only with the base part 3 in order to achieve the position shown in each case. The arrows V2, V4, V6, V8, V10 with the solid lines point in directions which, starting from the respective position shown, are to be followed accordingly with the changer 2 or only with the base part 3 to reach the next position. First, the changer 2, comprising the base part 3 and the changer part 4, located in the connecting position is moved towards the holder 5 in the direction V1. The status is that shown in FIG. 2A.

The changer 2 is then inserted horizontally at least substantially following the directions V2, V3—following the unlocking direction 34 relative to the holder—into the present U-shaped recess 21 of the holder 5 and positioned in such a way that the base part 3 overlaps the actuating means 29 as shown in FIG. 2B.

The changer 2 is then placed on the holder 5 following the direction V4, V5 at least substantially in the insertion direction 12, in this case vertically downwards. In this case, the actuating means 29 is received in the extracting direction 13 opposite to the insertion direction 12 in the receptacle 30 of the locking mechanism 16 of the base part 3. In this case, a securing element 42 is pressed out of the receptacle 30 by the actuating means 29 in such a way that the indicating element 31 of the indicating device 32 connected to the securing means 42 protrudes outwards from the base part 3. Furthermore, in the present and in this respect preferred embodiment, the pin-shaped engagement sections 22 of the holder 5 are introduced into the grooves 26 of the changer part 4. In this case, the support surfaces 23 of the engagement sections 22 pointing upwards here come into contact with the holding surfaces 25 pointing downwards here in the grooves 26 of the changer part 4. In principle, it is possible and not shown for the engagement section 22 to be provided on the changer part 4 and the holding surface 25 and/or the groove 26 on the holder 5. To hold the changer part 4 securely, there is a positive-locking connection between the changer part 4 and the holder 5, which acts selectively, i.e. depending on the position, in one or more directions, at least substantially horizontally and/or vertically. The status is then that shown in FIG. 2C, in which the locking mechanism 16 in the base part 3 is unlocked and released for an adjustment.

The changer 2 is then adjusted in the direction V6, V7 relative to the holder 5 in a locking direction 33, which is at least substantially aligned perpendicular to the insertion direction 12. However, the receptacle 30 is held by the actuating means 29 of the holder 5. As a result, a flap element 35 of the locking mechanism 16 on which the receptacle 30 is provided is adjusted relative to the base part 3 and thus adjusted relative to the base part 3 in the unlocking direction 34.

Furthermore, the engagement sections 22 are positioned relative to the changer part 4 in such a way that the changer part 4 can contact the engagement section 22 with respect to an extension from the holder 5 in the unlocking direction 34 relative to the holder 5 in the direction V6, V7 with an extension stop 36, in this an extension stop 36 in the groove 26. In addition, the changer part 4 can, with respect to an extraction from the holder 5 relative to the holder 5, abut with the extracting stop 36 on a securing surface 24 of the holder 5 facing away from the support surface 23 in the extracting direction 13, i.e. in the direction V8, V9. The locking mechanism 16 is adjusted from the locking position shown in FIG. 2C into the unlocking position according to FIG. 2D.

Now the base part 3 is pulled out of the changer part 4 in the extracting direction 13 opposite to the insertion direction 12, thus in the direction V8, V9, and simultaneously lifted off the holder 5, wherein the changer part 4 however remains securely held in the holder 5. In this case, the pin 14 is pulled out of the recess 17 with the bolts 15. In addition, the existing centring elements 19 are pulled out of the centring bores 20. This is shown in FIG. 2E. The base part 3 is lifted from the changer part 4 and the changer is in the separating position. The base part 3 is then moved, in this case, in the direction V10 relative to the holder 5 with the changer part 4 held, wherein the specific orientation of the direction V10 is not relevant to the method and another direction is possible.

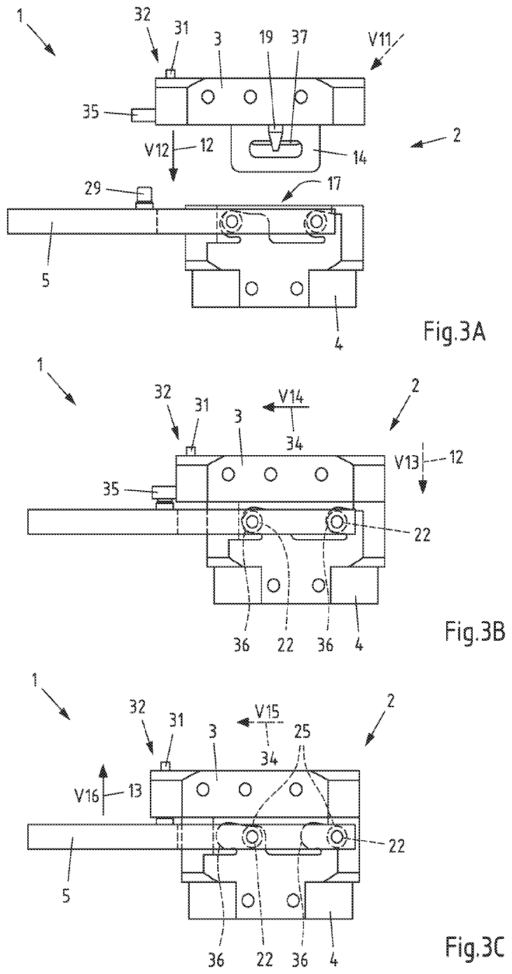

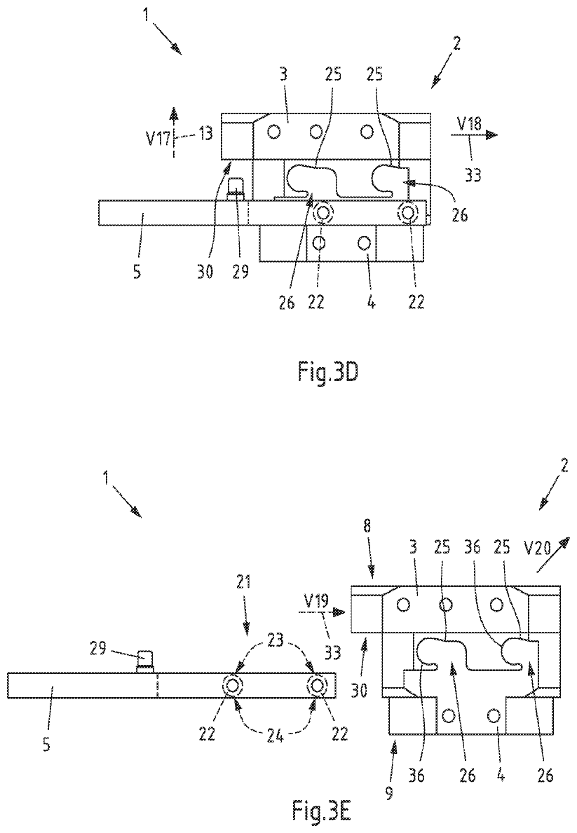

FIG. 3A-E shows the sequence of a further method, in particular one that can be combined consecutively with the method described above in which the changer 2 is brought back from the separating position into the connecting position. The base part 3 and the changer part 4 are connected in this way. Here, the arrows V11,V13,V15,V17,V19 with the arrows with dashed lines each point in the directions, which in FIG. 3A-B were only followed with the base part 3 and in FIG. 3C-E were followed with the changer 2 to reach the position shown in each case. The arrows V12,V14,V16,V18,V20 with the solid lines point in directions that are to be followed accordingly with the changer 2 or only with the base part 3 to reach the next position starting from the respective position shown. First, the base part 3 is brought from any direction, in this case in the direction V11, towards the held changer part 4 such that the base part 3 is arranged above the changer part 4. This is shown in FIG. 3A.

The base part 3, the locking mechanism 16 of which is arranged in the unlocking position, which results from the flap element 35 being pulled forwards out of the base part 3, is then placed on the holder 5 and the changer part 4 in the insertion direction 12, thus in the direction V12, V13. The base part 3 is thereby partially inserted into the changer part 4 and the receptacle 30 of the locking mechanism 16 is placed on the actuating means 29 of the holder 5 such that a positive-locking connection is achieved between the receptacle 30 and the actuating means 29, which acts in the horizontal direction, more precisely in the locking direction 33 and also in the unlocking direction 34. In the exemplary embodiment shown and in this respect preferred, the pin 14 is inserted into the recess 17 of the changer part 4 with bolts 15 that face away from one another and are adjustable with conical contact surfaces 37 of the locking mechanism 16, wherein for centring the two centring elements 19, of which one centring element 19 is shown, are dipped into a centring bore 20 of the changer part 4 that is not shown. The receptacle 30 is in this case adjustably mounted together with the flap element 35 in the locking direction 33 relative to the base part 3. This results in the status shown in FIG. 3B, in which the base part 3 and the changer part 4 are arranged in the connecting position.

The base part 3 is then adjusted together with the changer part 4 relative to the holder 5 in the direction V14, V15, i.e. in the unlocking direction 34, wherein the receptacle 30 and the flap element 35 are adjusted in relation to the base part 3 in the locking direction 33. By adjusting the receptacle 30 relative to the base part 3, the locking mechanism 16 moves from the unlocking position to the locking position. The changer part 4 and the base part 3 are then fixed to one another and blocked from being pulled apart by adjusting the base part 3 in the extracting direction 13 relative to the changer part 4, as shown in FIG. 3C.

The locked changer can then be lifted from the holder 5 in the extracting direction 13 relative to the holder 5, thus in the direction V16, V17. When lifted off, the indicating element 31 of the indicating device 32 is forced to retract into the base part 3. The actuating means 29 is pulled out of the receptacle 30 of the flap element 35 when lifted. At the same time, the restoring force of a spring means 38 presses the securing element 42 into the receptacle 30 from the other side. This adjustment causes the indicating element 31 connected to the securing element 42 to no longer protrude upwards out of the base part 3 after lifting the changer 2 from the holder 5. Subsequently, the changer 2 is adjusted in this case in relation to the holder 5 in the direction V18, V19.

No tool 7 is mounted on the changer part 4 here. In particular, if the tool 7 is large, the changer 2 is moved laterally after being lifted from the holder 5, i.e. in this case in the direction V18, V19, so that a collision between the tool 7 and the holder 5 cannot occur. This is shown in FIG. 3E. The changer 2 can then be moved further in any direction, as shown here by way of example with the direction V20.

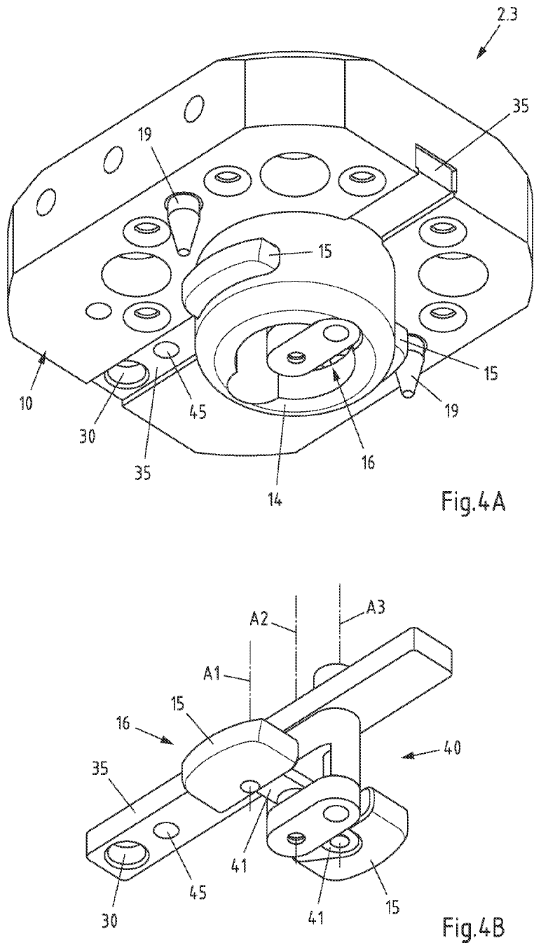

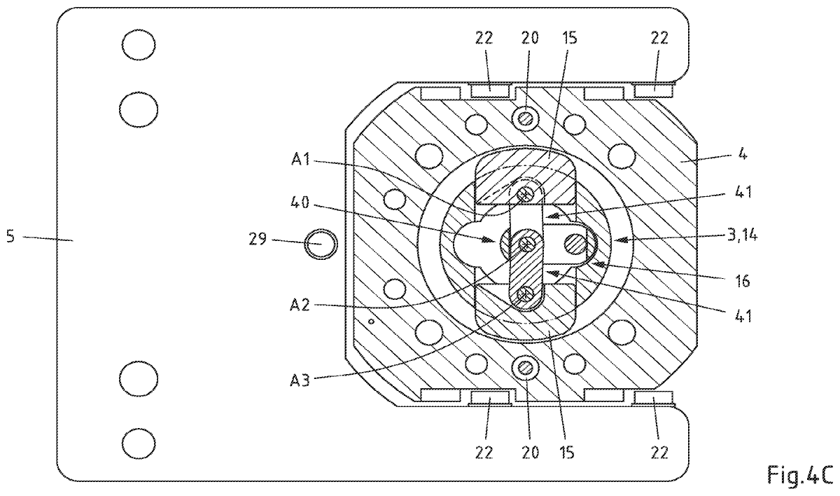

In FIG. 4A, the base part 3 with the locking mechanism 16 is shown in the locking position. The bolts 15, which are facing away from one another and can be moved at least substantially in a straight line, protrude laterally from the pin 14 on the base part 3, wherein the bolts 15 are designed for positive locking in the recess 17 of the changer part 4 (not shown) corresponding to the pin 14. In this case, the bolts 15 are designed in such a way that they, together with the pin 14, dip into the recess 17 of the changer part 4 and can then engage behind a projection 18 of the changer part 4. Other solutions, for example based on magnetism and/or frictional connection actuated by the locking mechanism 16, are not shown, but are also possible.

In the exemplary embodiment shown, the bolts 15 taper in the direction of their free ends and have conical contact surfaces 37, which are provided for sliding on the changer part 4 and can exert a locking force between the base part 3 and the changer part 4 in the insertion direction 12 of the base part 3 with respect to the changer part 4, as shown in FIG. 4C. Furthermore, two centring elements 19 are arranged on the base part 3, which are provided for engaging in centring bores 20 of a changer part 4 (not shown), so that the base part 3 and the changer part 4 can be centred against one another transverse to the insertion direction 12. Shown and in this respect preferred the centring elements 19 are provided on the base part 3 and the centring bores 20 on the changer part 4, wherein an alternative or supplementary reverse arrangement of centring bores 20 and centring elements 19 is possible. In addition, the flap element 35 is guided in a groove of the base part 3 here, wherein the flap element 35 has both the receptacle 30 and a further receptacle 45. The receptacle 30 and the further receptacle 45 are designed as passage openings in this case.

As shown in FIG. 4B, the bolts 15 are effectively connected via a toggle lever unit 40 to the flap element 35, which is adjustable at least substantially in a linear manner and guided in the base part 3 and has the receptacle 30. The bolts 15 are effectively connected to the flap element 35 by means of toggle levers 41 of the toggle lever unit 40 connected in an articulated manner at both sides. The bolts 15 are at least substantially adjustable transverse to the flap element 35, and the axes of rotation A1, A2, A3 of the toggle lever 41 are arranged at least substantially perpendicular to the locking direction 33 and to the unlocking direction 34 of the locking mechanism 16. In this case and in this respect preferred, the axes of rotation A1, A2, A3 are also arranged in parallel to the insertion direction 12 and to the extracting direction 13. An adjustment of the flap element 35 thus leads to an adjustment of the guided bolts 15 and to a maximum deflection of the bolts 15 in an outwards direction upon reaching a dead centre of the toggle lever unit 40. A further adjustment of the toggle lever unit 40 beyond the dead centre is shown in FIG. 4C in a sectional view, also comprising the changer part 4 and the holder 5.

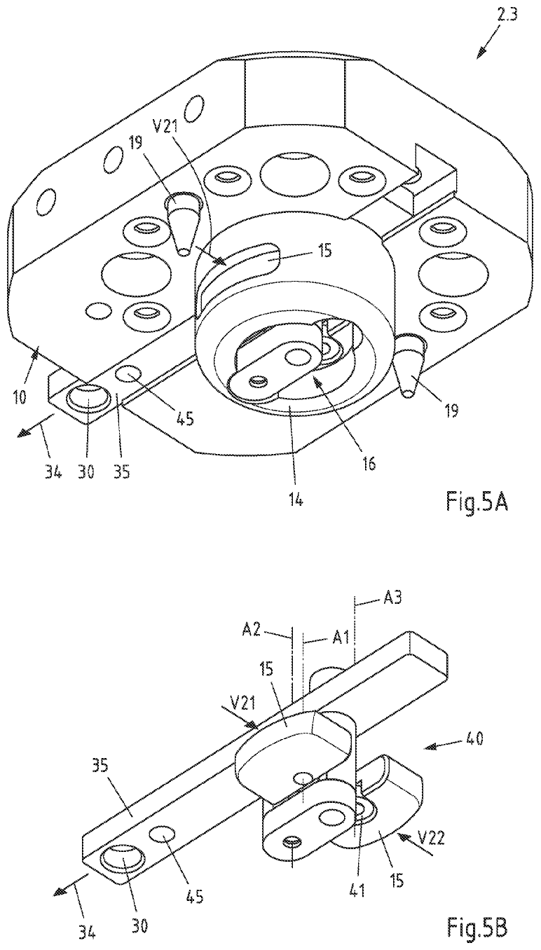

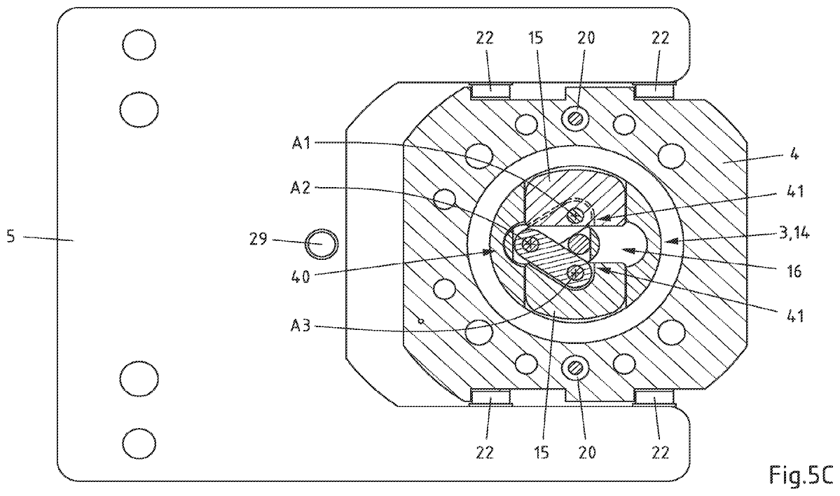

FIG. 5A shows the base part 3 opposite to FIG. 4A with its locking mechanism 16 in the unlocking position. The bolts 15 are in the present case, but do not have to be, in each case here in the opposite directions V21 and V22 completely retracted into the pins 14. The base part 3 can thus be pulled out of the changer part 4 or also placed on the changer part 4. The flap element 35 of the locking mechanism 16 is partially pulled out of the base part 3 in the unlocking direction 34. In FIG. 5B, the bolts 15 are shown accordingly in an approximate position. In FIG. 5C, the bolts 15 are shown in the position retracted into the pin 14, in which the bolts 15 do not engage behind this circumferential projection 18 of the recess 17 of the changer part 4.

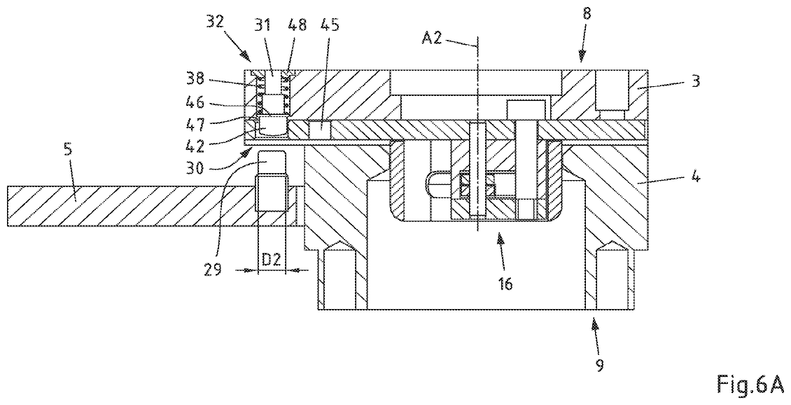

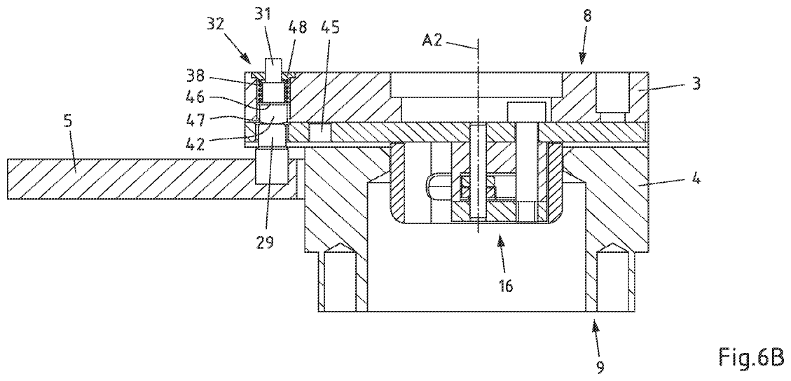

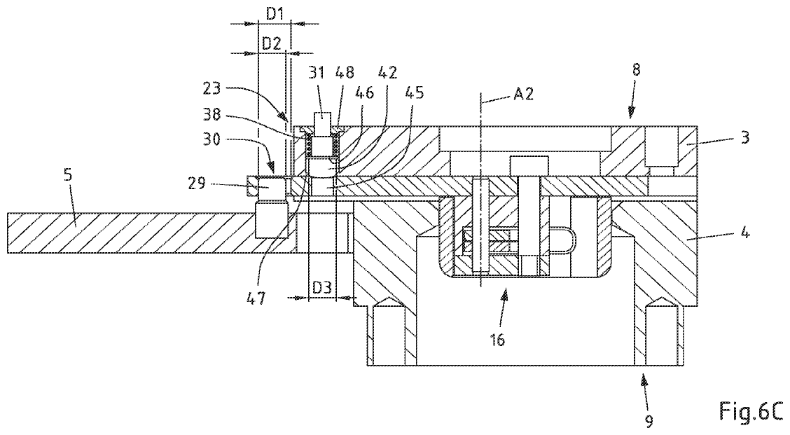

FIG. 6A-C shows how in the locking position of the locking mechanism 16 the flap element 35 is detachably secured against adjustment by means of the receptacle 30 and by means of a securing element 42 engaging in the receptacle 30 and can be released again for adjustment. In FIG. 6A, the changer 2 is shown in the connecting position and in a position from which the changer 2 can be placed on the actuating means 29 of the holder 5 in the insertion direction 12. The actuating means 29 is thus aligned at least substantially in a vertical direction with the receptacle of the flap element 35, so that when the changer 2 is set down (or is a word missing here?), a positive-locking connection is formed between the actuating means 29 and the receptacle 30, which is aligned at least substantially transverse to the insertion direction 12, i.e. in this case at least substantially horizontal. The securing element 42 engages in the receptacle 30 of the flap element 35 from above in the position shown in FIG. 6A. In this way, the securing element 42 blocks and secures the locking mechanism 16 against an adjustment in the unlocking direction 34 relative to the base part 3.

In this case and in this respect preferred, the receptacle 30 is designed to have a diameter D1 that is larger than the diameter of the actuating means D2 and the diameter of the securing element D3 in each case.

In the position shown in FIG. 6A, the securing element 42 strikes vertically in the direction of the receptacle 30 with the underside of a projection 46 of the securing element 42 on a lower projection 47 of the base part 3. In this case, the securing element 42 here and in this respect preferred is subjected to a restoring force with a spring means 38 in the direction of the receptacle 30, wherein the spring means 38 rests on the upper side of the projection 36 of the securing element 42.

When placing the changer 2 on the actuating means 29, the securing element 42 is displaced from the receptacle 30, as shown in FIG. 6B. The indicating element 31 connected to the securing element 42 is thereby adjusted upwards by the actuating means 29 against the restoring force of the spring means 38 until the securing element 42 is displaced from the receptacle 30. The indicating element 31 then projects upwards relative to the base part 3. The in particular pin-shaped indicating element 31 is here not necessarily connected in a one piece manner to the securing element 42, which is here not necessarily pin-shaped. The spring means 38 also ensures that a restoring force is applied to the securing element 42 and the indicating element 31 in the direction of the receptacle 30.

In the status of the changer system 1 shown FIG. 6B, the locking mechanism 16 with the flap element 35 is released from an adjustment relative to the base part 3, since the securing element 42 is completely pressed out of the receptacle 30 of the flap element 35. The locking mechanism 16 can thus be adjusted into the unlocking position.

In FIG. 6C, the locking mechanism 16 is shown displaced into the unlocking position. In this case, the indicating element 31 is further arranged in a position in which the indicating element 31 indicates the unlocked state of the locking mechanism 16. In addition, the securing element 42 protrudes, at least in sections, into the further receptacle 45 of the locking mechanism 16, more precisely of the flap element 35, in such a way that the securing element 42 remains held by the restoring force of the spring means 38 on the further receptacle 45 when the base part 3 is lifted off the changer part 4 and from the holder 5. The locking mechanism 16 is then held securely in the unlocking position.

### LIST OF REFERENCE NUMERALS

A1 Axis of rotation
A2 Axis of rotation
A3 Axis of rotation
D1 Diameter of the receptacle
D2 Diameter of the actuating means
D3 Diameter of the securing element
S Direction of gravity
V1 to V21 Direction
1 Changer system
2 Changer
3 Base part
4 Changer part
5 Holder
6 Robotic arm
7 Tool
8 Assembly section on the head side of the robotic arm
9 Assembly section on the base side of the tool
10 Insertion section of the base part
11 Insertion section of the changer part
12 Insertion direction
13 Extracting direction
14 Pins
15 Bolts
16 Locking mechanism
17 Recess of the changer part
18 Projection into the recess of the changer part
19 Centring element of the base part
20 Centring bore of the changer part
21 Holder recess
22 Engagement section of the holder
23 Support surface of the engagement section
24 Securing surface of the engagement section
25 Holding surface of the changer part
26 Groove of the changer part
27 U-cross member
28 U-legs
29 Actuating means of the holder
30 Receptacle of the locking mechanism
31 Indicating element of the indicating device
32 Indicating device
33 Locking direction
34 Unlocking direction
35 Flap element
36 Extracting stop of the changer part
37 Contact surfaces of the locking mechanism
38 Spring means
40 Toggle lever unit
41 Toggle lever
42 Securing element
45 Further receptacle of the locking mechanism
46 Projection of the securing element
47 Projection
48 Projection

1. A changer for changing tools to be used consecutively on a robotic arm, having a base part and a changer part,
wherein the base part provides an assembly section for mounting the robotic arm on the head side of the changer and the changer part provides an assembly section for mounting a tool on the base side of the changer,
wherein the base part and the changer part are connected to one another in a connecting position in such a way that the base part can be adjusted from the connecting position in an extracting direction at least substantially directed from the assembly section of the changer part to the assembly section of the base part relative to the changer part into a separating position separated from the changer part and back into the connecting position in an opposite insertion direction, and
wherein the base part has a locking mechanism interacting with the changer part and adjustable from a locking position, blocking a separation of the base part from the changer part from the connecting position in the extracting direction, into an unlocking position, releasing a separation of the base part from the changer part from the connecting position in the extracting direction, and back,
wherein
the locking mechanism has a receptacle for receiving an actuating means at least substantially in the extracting direction in the connecting position or an actuating means for inserting into a receptacle at least substantially in the insertion direction in the connecting position,
in that the locking mechanism is designed for positively receiving the actuating means in a locking direction at least substantially perpendicular to the extracting direction and/or in an unlocking direction at least substantially opposite the locking direction in the receptacle, and
in that the locking mechanism is designed to be adjustable from the unlocking position to the locking position by adjusting the receptacle or the actuating means in the unlocking direction relative to the base part and/or by adjusting the receptacle or the actuating means in the locking direction relative to the base part.

2. The changer according to claim 1,
wherein
the changer part has at least one holding surface, preferably at least two, in particular at least four, holding surfaces, in the extracting direction at least substantially opposite to the insertion direction, for holding the changer part in the direction of gravity (S) of a holder.

3. The changer according to claim 1,
wherein
the base part has a securing element for positive engagement in the unlocking direction into the receptacle of the locking mechanism, and in that, preferably, the securing element can be inserted at least substantially in the insertion direction in the receptacle and can be removed at least substantially in the extracting direction from the receptacle, and in that, further preferably, the receptacle is designed as a passage opening.

4. The changer according to claim 1,
wherein
an indicating device is provided to be adjustable from a position indicating the positive locking of the locking mechanism in the locking position to a position indicating the release of the locking mechanism in the locking position.

5. The changer according to claim 1,
wherein
the receptacle or the actuating means is provided on a flap element of the locking mechanism and in that the flap element allows the locking mechanism to be adjusted from the unlocking position to the locking position and back.

6. The changer according to claim 1,
wherein
the flap element is designed for actuating a toggle lever unit of the locking mechanism and that the toggle lever unit is provided for the locking and unlocking of base part and changer part.

7. The changer system having a changer for changing tools to be used consecutively on a robotic arm, comprising a robotic arm connected to the base part by means of the assembly section of the base part and/or a tool connected to the changer part by means of the assembly section of the changer part,
wherein
the changer is designed according to claim 1.

8. The changer system according to claim 7,
characterised by
a holder supporting the changer part in the separating position in the direction of gravity (S) for holding the changer part separated from the base part.

9. The changer system according to claim 7,
wherein
the holder has at least one support surface corresponding to the holding surface of the changer part, in particular at least two or four support surfaces corresponding to the at least two or four holding surfaces of the changer part, and/or in that the holder has the at least one, in particular at least substantially pin-shaped, actuating means or the receptacle.

10. The changer system according to claim 7,
wherein
the holder has a recess, wherein the recess is U-shaped, and wherein, preferably, the actuating means on the U-cross member and/or the support surfaces are provided at least substantially opposite and/or facing away from one another on the two U-legs.

11. The changer system according to claim 7,
wherein
the holder has at least one securing surface, in particular at least two or four securing surfaces, and that, preferably, a securing surface is provided opposite and/or facing away from a support surface in the extracting direction and in that, more preferably, a positive-locking connection can be effected by means of the at least one securing surface between the holder and the changer part at least in the extracting direction.

12. A method for changing a tool,
having a changer system according to claim 7,
in which the base part is placed in the connecting position with a receptacle or with an actuating means relative to a holder in the insertion direction on an actuating means fixed on the holder or is inserted in a receptacle fixed on the holder,
in which the base part is adjusted relative to the holder in the locking direction after being placed on the actuating means or after being inserted into the receptacle and
in which, by adjusting the base part in the locking direction, the receptacle or the actuating means is adjusted relative to the base part in the unlocking direction and the actuating means interacts positively with the locking mechanism and the locking mechanism is adjusted from the locking position to the unlocking position.

13. The method for changing a tool according to claim 12,
in which, after adjusting the locking mechanism to the unlocking position, the base part is lifted from the connecting position relative to the changer part in the extracting direction, and
in which the changer part is held in the direction of gravity (S) after lifting the base part from the holder.

14. The method for changing a tool according to claim 12,
in which, when placing the receptacle on the actuating means or when inserting the actuating means into the receptacle, in particular by the actuating means, a securing element is preferably forcefully moved out of the receptacle and the actuating means engages in the receptacle, in particular in the section of the receptacle released by the securing element.

15. The method for changing a tool,
having a changer system according to claim 7,
is inserted into a changer part held by a holder in the insertion direction,
in which the base part is placed with a receptacle or with an actuating means in the insertion direction relative to the holder on an actuating means fixed on the holder or is inserted in a receptacle fixed on the holder,
in which the base part is adjusted relative to the holder in the unlocking direction after being placed on the actuating means or after being inserted into the receptacle and
in which, by adjusting the base part in the unlocking direction, the receptacle or the actuating means is adjusted relative to the base part in the locking direction and the actuating means or the receptacle interacts positively with the locking mechanism and the locking mechanism is adjusted from the unlocking position to the locking position.

16. The method for changing a tool according to claim 15,
in which, after adjusting the locking mechanism to the locking position, the changer is lifted in the connecting position relative to the holder in the extracting direction.

17. The method for changing a tool according to claim 15,
in which, by lifting the changer from the actuating means or from the receptacle, a securing element preferably forcefully engages positively in the receptacle for securing the locking mechanism in the locking position.
